(19) United States
(12) Patent Application Publication
(10) Pub. No.: US 2025/0278454 A1
(43) Pub. Date: Sep. 4, 2025

(54) COMPUTING SYSTEM AND METHOD FOR CONTROLLING COMPUTING SYSTEM

(71) Applicant: Fujitsu Limited, Kawasaki-shi (JP)

(72) Inventor: Makiko ITO, Kawasaki (JP)

(73) Assignee: Fujitsu Limited, Kawasaki (JP)

(21) Appl. No.: 19/009,460

(22) Filed: Jan. 3, 2025

(30) Foreign Application Priority Data
Mar. 1, 2024 (JP) 2024-031135

(51) Int. Cl. G06F 17/16

(52) U.S. Cl. CPC G06F 17/16

(57) ABSTRACT

A computing system includes: a plurality of accelerators that perform matrix multiplication computations; a cache memory that caches data of an external memory that saves a computation result by each of the plurality of accelerators; and a controller configured to: determine whether or not an access to the cache memory is congested; and in a case where it is determined that the access is congested, control the cache memory to perform conversion for reducing accuracy of a value of each component of a matrix on the matrix read from the external memory in response to an access from one accelerator that is one of the plurality of accelerators and is configured to perform the matrix multiplication computation of the matrix and another matrix saved in the external memory, and to transfer the matrix.

### CROSS-REFERENCE TO RELATED APPLICATION

This application is based upon and claims the benefit of priority of the prior Japanese Patent Application No. 2024-31135, filed on Mar. 1, 2024, the entire contents of which are incorporated herein by reference.

### FIELD

The embodiment discussed herein is related to a computing system and a method for controlling a computing system.

### BACKGROUND

There is a demand for an increase in speed of computation processing for realizing artificial intelligence (AI) (hereinafter, referred to as “AI processing”), and several techniques therefor have been proposed.

Japanese National Publication of International Patent Application No. 2022-523912, Japanese Laid-open Patent Publication No. 2023-77818, U.S. Patent Application Publication No. 2019/0354846, U.S. Patent Application Publication No. 2020/0258263, and U.S. Patent Application Publication No. 2022/0044114 are disclosed as related art.

### SUMMARY

According to an aspect of the embodiments, a computing system includes: a plurality of accelerators that perform matrix multiplication computations; a cache memory that caches data of an external memory that saves a computation result by each of the plurality of accelerators; and a controller configured to: determine whether or not an access to the cache memory is congested; and in a case where it is determined that the access is congested, control the cache memory to perform conversion for reducing accuracy of a value of each component of a matrix on the matrix read from the external memory in response to an access from one accelerator that is one of the plurality of accelerators and is configured to perform the matrix multiplication computation of the matrix and another matrix saved in the external memory, and to transfer the matrix.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a flow of computation in AI processing;

FIG. 2 is a diagram illustrating an example of a configuration of a computing system;

FIG. 3 is a diagram for describing an example of a detailed configuration of a computing unit;

FIG. 4 is a diagram illustrating an example of an internal configuration of a processing element (PE);

FIG. 5 is a diagram illustrating an example of an exponent part range table;

FIG. 6 is a flowchart illustrating processing contents of a first example of processing performed by an accelerator;

FIG. 7 is a flowchart illustrating processing contents of a second example of the processing performed by the accelerator;

FIG. 8 is a flowchart illustrating processing contents of an example of processing performed by a memory controller;

FIG. 9 is a flowchart illustrating processing contents of an example of accuracy determination processing; and

FIG. 10 is a flowchart illustrating processing contents of an example of read processing.

### DESCRIPTION OF EMBODIMENTS

In most of the AI processing, majority part of the processing is occupied by a matrix multiplication computation. For example, in the AI processing by the implementation of a deep neural network model, processing of performing a matrix multiplication computation at a next stage by using a matrix of a computation result by a matrix multiplication computation at a previous stage is repeated.

A computing system that realizes high-speed AI processing by using a computation device (accelerator) suitable for a matrix multiplication computation is widely known. While a speed of the matrix multiplication computation itself has been increased by improvement in performance of the accelerator due to improvement in a degree of integration or the like, improvement in performance of a memory bandwidth in data transfer to and from a memory that saves the computation result has not caught up. This is one of factors that hinder an increase in speed of the AI processing.

In one aspect, an object of the present disclosure is to efficiently use a memory bandwidth.

Hereinafter, embodiments will be described in detail with reference to the drawings.

First, a flow of computation in AI processing will be described.

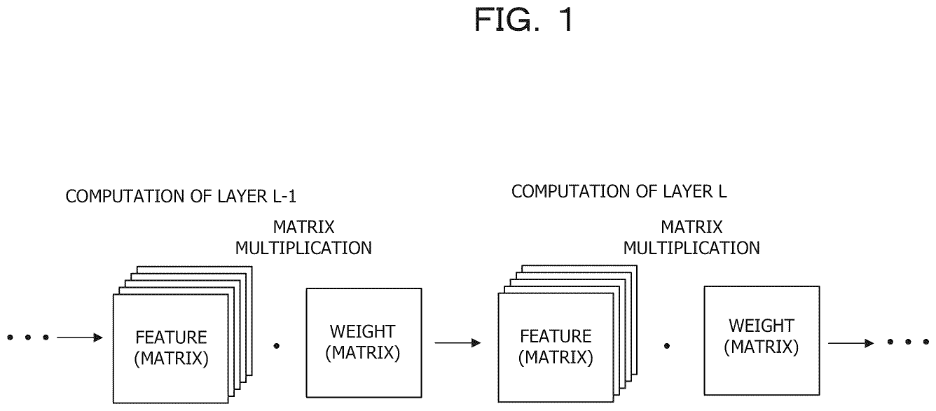

FIG. 1 schematically illustrates an example of the flow of the computation in the AI processing. This example illustrates a case where the AI processing is realized by using a deep neural network model. FIG. 1 illustrates an example of a case where there is no computation of an activation function.

In the AI processing realized by using the deep neural network model, a matrix multiplication computation of a matrix having features as components and a matrix having weights as components is performed in parallel as processing of each layer. A matrix of a computation result in a previous-stage layer (layer L-1 in FIG. 1) (or a matrix including this computation result and a computation result of an activation function) becomes an input of the matrix multiplication computation with the matrix having the weights as the components in a next-stage layer (layer L in FIG. 1).

In a case where the above-described model is implemented in a computing system including an accelerator chip having a plurality of accelerators suitable for the matrix multiplication computation, the plurality of accelerators execute a plurality of matrix multiplication computations in each layer in a distributed manner. In a case where a scale of the model to be implemented at this time is large, an external memory coupled to the accelerator chip is used as a storage area for temporarily saving a large amount of data handled in each layer.

A speed of the matrix multiplication computation itself has been increased by the improvement of the performance of the accelerator due to the improvement of a degree of integration or the like. On the other hand, improvement in performance of a memory bandwidth in data transfer to and from the external memory for temporarily saving data of each layer has not caught up.

For example, a computing system including an accelerator chip having 16 accelerators in each of which a computing unit is constituted by a systolic array including 64×64 PEs. The systolic array is widely known as one of configurations of the computing unit having an advantage of efficient execution of the matrix multiplication computation. The “PE” is an abbreviation for processing element. One PE has one multiplier and one adder, and performs a product-sum computation of components of each of two matrices that are targets of the matrix multiplication computation to calculate a value of one component in the matrix of the result of the matrix multiplication computation.

Assuming that a clock frequency in this computing system is 500 MHz, a theoretical computation capability of this system is 2 (multiplication and addition)×64×64 [pieces]×16 [pieces]×500 [MHz]≈65 [TFLOPS]. On the other hand, a HBM3 DRAM which has recently started to be used as a high-speed external memory has a memory bandwidth of 819 GB/s. The “HBM” is an abbreviation for high bandwidth memory, and the “DRAM” is an abbreviation for dynamic random-access memory.

As described above, a performance gap between the memory bandwidth of the external memory and the computation performance of the matrix multiplication computation is large. The technical difficulty of increasing the memory bandwidth is high, and a dramatic improvement is not expected at present. In order to improve such a performance gap, a cache memory that caches data saved in the external memory may be used.

A cache memory disposed at a position farthest from a processing apparatus, for example, a cache memory disposed at a position closest to the external memory is, for example, referred to as an LLC. The “LLC” is an abbreviation for last level cache. By making a configuration such that the LLC is inserted between the accelerator chip and the external memory, a difference in performance between the accelerator and the external memory may be expected to fill. However, when the plurality of accelerators included in the accelerator chip share the LLC, a situation in which the plurality of accelerators compete for a memory bandwidth of the LLC occurs.

Incidentally, in the AI processing by the model described above, a large number of matrix multiplication computations are to be executed, but high accuracy is rarely desired for the computations. In the embodiment to be described below, attention is paid to such a characteristic of a request for the matrix multiplication computation in the AI processing, and the matrix multiplication computation which is repeatedly executed hierarchically may be performed in a short time.

In the present embodiment, when the result of the matrix multiplication computation in the previous-stage layer is obtained, the matrix of the computation result is stored in the external memory, and a range of a value taken by an exponent part in a floating-point numerical value of each component of the matrix is obtained and saved in a table of a memory controller. When processing of the next-stage layer is performed, the memory controller controls the LLC in accordance with a degree of congestion of access to the LLC and causes the LLC to perform conversion for reducing the accuracy of the value of each component of the matrix of the computation result in the previous-stage layer. The memory controller determines the accuracy of the converted value in this conversion, based on the range of the value represented in the table. This determination is made by selecting a representation format (data format) of the floating-point numerical value of each component of the matrix that is the target of the matrix multiplication computation in the next-stage layer. The memory controller transfers the converted matrix received from the LLC to the accelerator in charge of the matrix multiplication computation in the processing of the next-stage layer.

In the present embodiment, as described above, in a case where a representation format with low-precision representation is selected, the amount of data representing the value of the matrix computation result is reduced. As a result, since the amount of data transferred from the LLC to the accelerator is reduced, the memory bandwidth of the LLC may be effectively used, and consequently the memory bandwidth of the external memory may be effectively used.

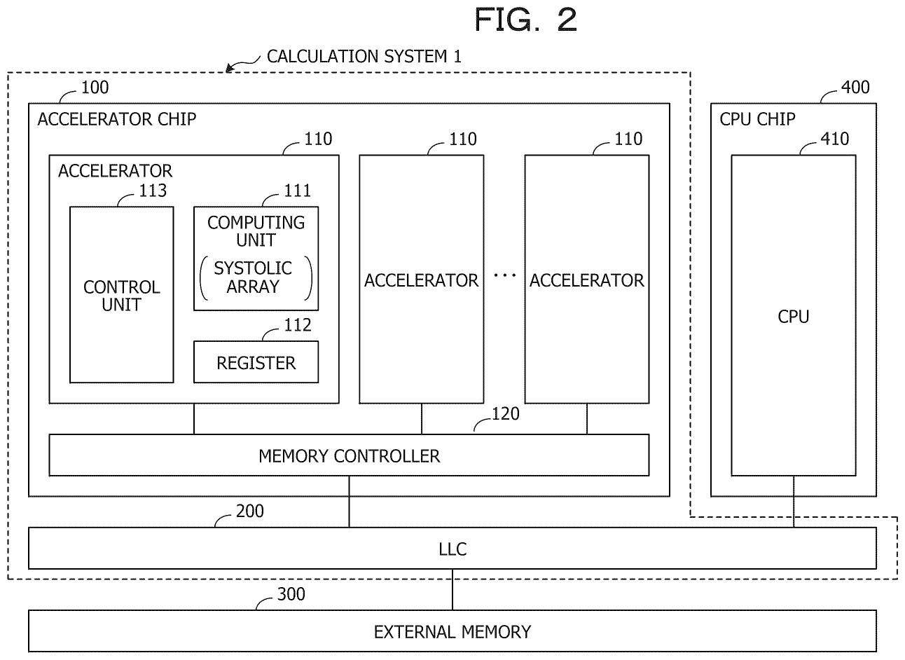

Next, a configuration of the computing system according to the present embodiment will be described. FIG. 2 illustrates an example of a configuration of a computing system 1. This computing system 1 performs the AI processing described with reference to FIG. 1 at a high speed.

The computing system 1 includes an accelerator chip 100 and an LLC 200, and is coupled to an external memory 300.

The accelerator chip 100 is coupled to the external memory 300 via the LLC 200. The accelerator chip 100 includes a plurality of accelerators 110 and a memory controller 120.

Each of the plurality of accelerators 110 includes a computing unit 111, a register 112, and a control unit 113.

The computing unit 111 performs the matrix multiplication computation. In the present embodiment, the systolic array described above is used as the computing unit 111.

The register 112 stores and temporarily retains data (the value of each component of the matrix) input to and output from the computing unit 111.

The control unit 113 controls the computing unit 111 and the register 112.

The external memory 300 stores and saves the computation result by each of the plurality of accelerators 110 included in the accelerator chip 100, for example, the matrix of the computation result in the previous-stage layer in the matrix multiplication computation described with reference to FIG. 1. The LLC 200 is a cache memory that caches data of this external memory 300.

The memory controller 120 controls operations of the LLC 200 and the external memory 300.

In the present embodiment, one of controls performed by the memory controller 120 is to transfer a matrix read from the external memory 300 after performing conversion for reducing the accuracy of the value of each component of the matrix. This matrix is read from the external memory 300 in response to an access from the accelerator 110 that performs the matrix multiplication computation of this matrix and another matrix. The memory controller 120 determines whether or not the access to the LLC 200 is congested, and performs this control when it is determined that the access is congested.

In the present embodiment, to perform the above-described determination, the memory controller 120 includes a FIFO memory (not illustrated) that temporarily stores, as a queue, accesses from the plurality of accelerators 110 to the external memory 300. The “FIFO” is an abbreviation for first in first out. The memory controller 120 compares the number of accesses retained in the FIFO memory with a predetermined threshold value. As a result of this comparison, in a case where the number of accesses exceeds the threshold value, the memory controller 120 determines that the access to the LLC 200 is congested.

The method by which the memory controller 120 determines whether or not the access to the LLC 200 is congested is not limited to the above-described method, and various other methods may be adopted. For example, when the memory controller 120 receives an access to the external memory 300, it may be determined whether or not the memory controller 120 itself is performing control processing for the LLC 200 in response to another access to the external memory 300. In this case, the memory controller 120 determines that the access to the LLC 200 is congested in a case where this control processing is being performed.

In the configuration example illustrated in FIG. 2, a CPU chip 400 having a CPU 410 is coupled to the LLC 200. The CPU 410 controls the computing system 1. The “CPU” is an abbreviation for central processing unit. For example, the CPU 410 provides each of the plurality of accelerators 110 with the matrix having the weights as the components, among matrices that are computation targets in the matrix multiplication computation described with reference to FIG. 1.

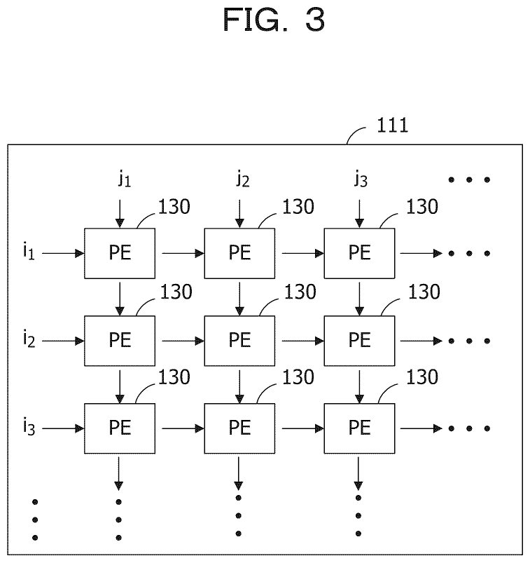

Next, an example of a detailed configuration of the computing unit 111 included in the accelerator 110 in FIG. 2 will be described with reference to FIG. 3.

As illustrated in FIG. 3, the accelerator 110 is formed by disposing a plurality of PE 130 vertically and horizontally, and for example, is constituted by 64×64 PEs 130 in which 64 PEs 130 are disposed vertically and 64 PEs 130 are disposed horizontally. Components of individual rows i₁, i₂, i₃, . . . of a matrix A are sequentially input to inputs of the respective PEs 130 arranged in a horizontal line, and components of individual columns j₁, j₂, j₃, . . . of a matrix B are sequentially input to inputs of the respective PEs 130 arranged in a vertical line, among the plurality of PEs 130.

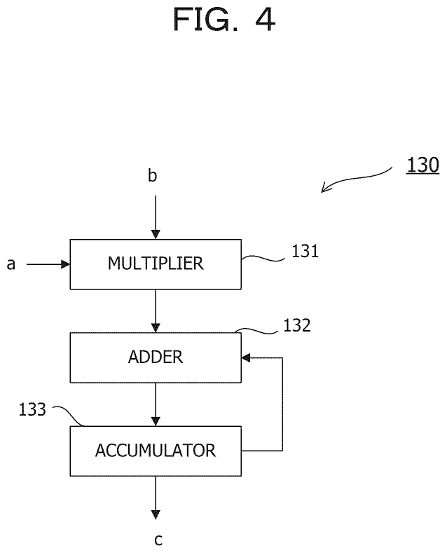

FIG. 4 illustrates an example of an internal configuration of the PE 130. The PE 130 includes a multiplier 131, an adder 132, and an accumulator 133.

The multiplier 131 multiplies a component a input to the PE 130 in a row i of the matrix A by a component b input to the PE 130 in a column j of the matrix B, and outputs a multiplication result to the adder 132.

The adder 132 adds the multiplication result obtained by the multiplier 131 and a value stored in the accumulator 133, and outputs an addition result to the accumulator 133. The accumulator 133 stores the addition result obtained by the adder 132 and outputs a stored value c. For example, the adder 132 and the accumulator 133 sequentially add the multiplication results sequentially output from the multiplier 131.

The PE 130 has the above-described configuration, and executes a computation represented by an expression below. For example, the PE 130 performs a product-sum computation of a k-th component A[i][k] in a row i of the matrix A and a k-th component B[k][j] in a column j of the matrix B, where k is a variable. The PE 130 outputs, as a computation result, a value C[i][j] of the component corresponding to the row i and the column j in a matrix C which is a matrix multiplication of the matrix A×the matrix B.

$$C [ i ] ⌈ j ] = {\sum }_{k = 1}^{K} A [ i ] [ k ] \cdot B [ k ] [ j ]$$

As described above, in the present embodiment, the systolic array is adopted as the configuration of the computing unit 111 included in the accelerator 110. However, another configuration having excellent performance in executing the matrix multiplication computation may be adopted as the configuration of the computing unit 111.

In the present embodiment, it is assumed that the accelerator 110 supports computations of floating-point numbers in various representation formats. For example, it is assumed that the PEs 130 included in each accelerator 110 of the accelerator chip 100 are capable of executing computations with floating-point numbers represented by well-known representation formats of FP32, FP16, BF16, and FP8 and a recently used representation format of FP19. It is assumed that the values of the individual components of the matrix of the result of the matrix multiplication computation output from the accelerator 110 are represented in the FP32 format.

The FP32 format has bit widths of 1 bit for positive and negative signs, 8 bits for an exponent part, and 23 bits for a mantissa part. The FP16 format has bit widths of 1 bit for positive and negative signs, 5 bits for an exponent part, and 10 bits for a mantissa part. The BF16 format has bit widths of 1 bit for positive and negative signs, 8 bits for an exponent part, and 7 bits for a mantissa part. The FP8 format has variations of E5M2 and E4M3. The E5M2 has bit widths of 1 bit for positive and negative signs, 5 bits for an exponent part, and 2 bits for a mantissa part. The E4M3 has bit widths of 1 bit for positive and negative signs, 4 bits for an exponent part, and 3 bits for a mantissa part. The FP19 format has bit widths of 1 bit for positive and negative signs, 8 bits for an exponent part, and 10 bits for a mantissa part. Therefore, the representation format that may represent a value with the highest accuracy, among the representation formats of the floating-point numbers of which computation execution is supported by the accelerator 110, is the FP32 format.

In the present embodiment, the accelerator 110 acquires, from an outside, information on the representation format of the floating-point number representing the value of each component of the input matrix, for example, the matrix that is the target of the matrix multiplication computation. The multiplier 131 of each of the PEs 130 included in the accelerator 110 is configured to multiply the individual components of the matrix represented in the representation format indicated by the acquired information, and sequentially output the values of the multiplication results to the adder 132 in the FP32 format. On the other hand, the adder 132 and the accumulator 133 are configured to perform sequential addition of the values of the multiplication results sequentially output from the multiplier 131 with accuracy corresponding to the FP32 format, and output the values of the results of the sequential addition in the FP32 format. As described above, the configuration is made such that the sequential addition by the adder 132 and the accumulator 133 is constantly performed with high accuracy corresponding to the accuracy of the FP32 format regardless of the information acquired from the outside, and thus, deterioration in the computation accuracy due to the product-sum computation by the PE 130 is suppressed.

The memory controller 120 acquires the information on the representation format of the floating-point number in which the accelerator 110 supports the execution of the computation directly from the CPU 410 or via the accelerator 110. The memory controller 120 sets, as options, the representation formats indicated by the acquired information, and selects the precision after conversion in the conversion to be performed by the LLC 200, for example, the conversion for reducing the precision of the values of the individual components of the matrix, from among the options. Next, this selection method will be described.

In the following description, among the plurality of accelerators 110, an accelerator that has written the matrix before the aforementioned conversion to the external memory 300, for example, an accelerator that has output the matrix before the conversion as the computation result is referred to as a “previous-stage accelerator 110”. Among the plurality of accelerators 110, an accelerator that performs the matrix multiplication computation by using the matrix in which the accuracy of the values of the individual components is reduced by the aforementioned conversion by the LLC 200 is referred to as a “next-stage accelerator 110”.

When the matrix before the aforementioned conversion, for example, the matrix of the result of the matrix multiplication computation is written to the external memory 300, the previous-stage accelerator 110 obtains a range (a maximum value and a minimum value) of the value taken by the exponent part in the value of each component of this matrix represented in the representation format of the floating-point number. The previous-stage accelerator 110 notifies the memory controller 120 of the obtained range of the value.

When the notification of the range of the value is received from the accelerator 110, the memory controller 120 adds the range of the value to an exponent part range table saved in a storage unit (not illustrated) included in the memory controller 120 itself.

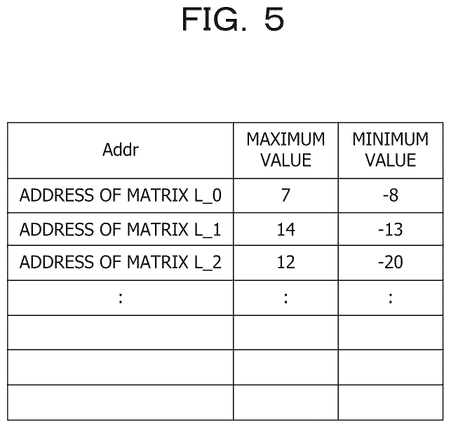

FIG. 5 illustrates an example of the exponent part range table. In the exponent part range table, the range (the maximum value and the minimum value) of the value taken by the exponent part in the value of each component of the matrix of the result is indicated in association with an address (for example, a head address) of the storage area of the external memory 300 in which the previous-stage accelerator 110 writes the matrix of the result of the matrix multiplication computation.

Thereafter, the next-stage accelerator 110 makes an inquiry to the memory controller 120 to obtain information on the accuracy of the value of each component of the matrix which is the computation target of the matrix multiplication computation performed by the next-stage accelerator 110 itself. When the inquiry is received, the memory controller 120 reads, from the exponent part range table, the range of the value taken by the exponent part in the value of each component of the matrix of the result of the matrix multiplication computation by the previous-stage accelerator 110. The memory controller 120 selects, from among the representation formats included in the aforementioned options, a representation format that has, as the exponent part, a bit width capable of representing the value in the read range and that uses the smallest number of bits for representing the value. By configuring the memory controller 120 to select such a representation format, the occurrence of an overflow or an underflow in the converted value is suppressed.

The accuracy after the conversion of the value of each component of the matrix of the computation result by the previous-stage accelerator 110 is determined as described above. Thereafter, the memory controller 120 controls the LLC 200 to convert the representation format of the value of each component of the matrix read from the external memory 300 by the access into the selected representation format, and then sends the value to the next-stage accelerator 110.

For example, it is assumed that the memory controller 120 acquires information indicating that the representation formats of the floating-point numbers supported by the accelerator 110 are FP32, FP16, BF16, FP8 (E5M2 and E4M3), and FP19 formats. In this case, it is assumed that the range of the value taken by the exponent part in the value of each component of the matrix of the computation result of the matrix multiplication computation which the previous-stage accelerator 110 notified the memory controller 120 of is indicated in a first row of the exponent part range table of FIG. 5.

The first row of the exponent part range table of FIG. 5 indicates that the maximum value is “+7” and the minimum value is “−8” in the range of the value taken by the exponent part in the value of each component of the matrix. Therefore, the range of this value may not be represented by 4 bits in which the range of the value that may be represented is −7 to +8, and at least 5 bits in which the range is −14 to +15 are desired as the bit width of the exponent part.

In the case of the example described above, among the representation formats of the floating-point numbers supported by the accelerator 110, there are the FP16 format and the FP8 format of the E5M2 type in which the bit width of the exponent part is 5 bits. The FP8 format of the E5M2 type is a representation format in which the floating-point number is represented by 1 octet (8 bits), and the FP16 format is a representation format in which the floating-point number is represented by 2 octets (16 bits). Therefore, in both of the FP16 format and the FP8 format of the E5M2 type, the number of bits used to represent the value is smaller the FP32 format in which the floating-point number is represented by four octets (32 bits). In the FP8 format of the E5M2 type, of the FP16 format and the FP8 format of the E5M2 type, the number of bits used to represent the value is smaller than the FP16 format. Therefore, in the case of this example, the memory controller 120 selects the FP8 format of the E5M2 type, and instructs the LLC 200 to convert the value of each component of the matrix into the representation in the FP8 format of the E5M2 type, as the conversion for reducing the accuracy of the value of each component of the matrix.

In the conversion of the representation format of each component of the matrix, the occurrence of an overflow in the converted value is not allowed, but the occurrence of an underflow may be allowed. To do so, the memory controller 120 may select a representation format that has a bit width capable of representing the maximum value of the values in the read range as the exponent part and that has the smallest number of bits used to represent the value.

The memory controller 120 controls the LLC 200 as described above to convert the matrix, which is read from the external memory 300 and of which each component is represented in the FP32 format, so as to reduce the accuracy of the matrix, and then transfers the matrix to the next-stage accelerator 110. The next-stage accelerator 110 having received this converted matrix performs the matrix multiplication computation on the converted matrix and another matrix as described above. In this matrix multiplication computation, the multiplication of each component of the matrix with the accuracy after the conversion and the sequential addition of the multiplication result with the accuracy corresponding to the FP32 format, for example, the sequential addition with the accuracy before the conversion are performed. The next-stage accelerator 110 writes the matrix of the computation result of this matrix multiplication computation to the external memory 300. At this time, the value represented in the FP32 format is written to the external memory 300, as the value of each component of the matrix of the computation result.

Hereinafter, the flow of the above-described processing performed by each of the accelerator 110 and the memory controller 120 will be described with reference to the drawings.

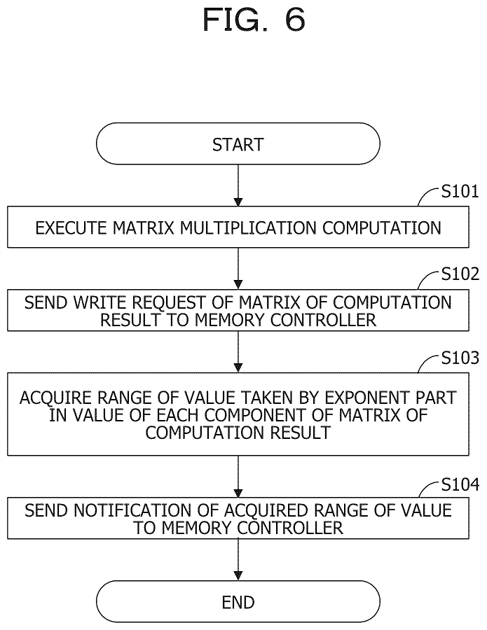

First, an example of processing performed by the accelerator 110 as processing of a first layer among the processing for each layer in the AI processing will be described with reference to a flowchart of FIG. 6.

When the processing of FIG. 6 is started, first, in S101, processing of executing the matrix multiplication computation as the processing of the first layer as described above is performed.

In this processing of S101, a matrix multiplication computation of a matrix (the matrix of the features in the example of FIG. 1) having input values from an input unit (not illustrated) of the computing system 1 as components and a matrix (the matrix of the weights in the example of FIG. 1) acquired by the accelerator 110 in advance before the start of the processing of FIG. 6 is executed. In this matrix multiplication computation, the multiplication of the matrix in which each component is represented in the representation format capable of representing the value with the highest accuracy, among the representation formats of the floating-point numbers in which the accelerator 110 supports the execution of the computation is executed. Therefore, in the present embodiment, each component of the matrix that is the target of the matrix multiplication computation at this time is represented in the FP32 format.

In S102, processing of sending a write request including the matrix of the result of the matrix multiplication computation obtained by the processing of S101 to the memory controller 120 is performed. This write request is a request to write the matrix of the result of the matrix multiplication computation to the external memory 300.

In S103, processing of acquiring the range (the maximum value and the minimum value) of the value taken by the exponent part in the value of each component of the matrix from the matrix of the result of the matrix multiplication computation obtained by the processing of S101 is performed.

In S104, processing of sending the notification for notifying the range of the value acquired by the processing of S103 to the memory controller 120 is performed, and then, the processing of FIG. 6 is ended.

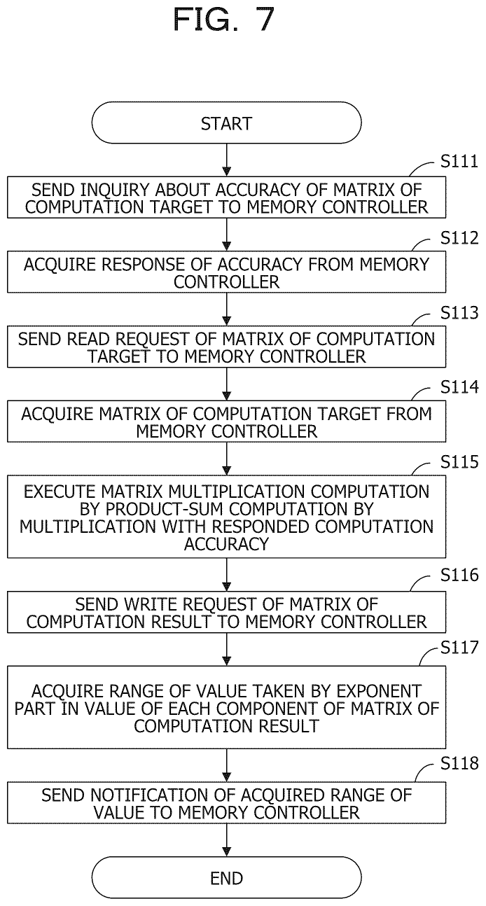

Next, an example of processing performed by the accelerator 110, as processing of each layer after a second layer among the processing for each layer in the AI processing will be described with reference to a flowchart of FIG. 7.

When the processing of FIG. 7 is started, first, in S111, processing of sending, to the memory controller 120, the inquiry for obtaining the information on the accuracy of the value of each component of the matrix that is the target of the matrix multiplication computation executed by processing to be described later is performed. This matrix of the computation target is a matrix saved in the external memory 300, for example, a matrix of the computation result of the matrix multiplication computation by the previous-stage accelerator 110.

In S112, processing of acquiring a response about the information on the accuracy of the value of each component of the matrix, which is sent from the memory controller 120 in response to the inquiry sent by the processing of S111, is performed.

In S113, processing of sending, to the memory controller 120, a read request from the external memory 300 for a matrix of the computation target of the matrix multiplication computation executed by processing to be described later is performed.

In S114, processing of acquiring the matrix sent from the memory controller 120 in response to the read request sent by the processing of the S113 is performed. The value of each component of the matrix acquired by this processing is represented in the representation format indicated by the response acquired by the processing of S112.

In S115, processing of executing the matrix multiplication computation of the matrix acquired by the processing of S114 and the matrix (for example, the matrix of the weights in FIG. 1) acquired by the accelerator 110 in advance before the start of the processing of FIG. 7 is performed.

In S116, processing of sending the write request including the matrix of the result of the matrix multiplication computation by the processing of S115 to the memory controller 120 is performed. This write request is a request to write the matrix of the result of the matrix multiplication computation to the external memory 300.

In S117, processing of acquiring the range (the maximum value and the minimum value) of the value taken by the exponent part in the value of each component of the matrix from the matrix of the result of the matrix multiplication computation by the processing of S115 is performed.

In S118, processing of sending the notification for notifying the memory controller 120 of the range of the value acquired by the processing of S117 to the memory controller 120 is performed, and then, the processing of FIG. 7 is ended.

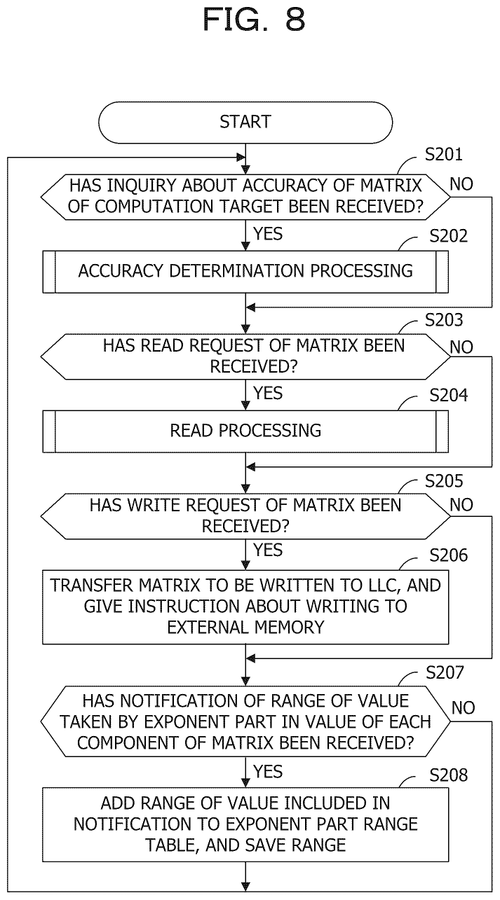

Next, an example of processing performed by the memory controller 120 will be described with reference to a flowchart of FIG. 8.

When the processing of FIG. 8 is started, first, in S201, processing of determining whether or not the inquiry about the information on the accuracy of the value of each component of the matrix which is the computation target has been received is performed. This inquiry is sent from the accelerator 110 by the processing of S111 of FIG. 7 described above.

When it is determined that the inquiry has been received in determination processing of S201 (when the determination result is YES), the processing proceeds to S202, the accuracy determination processing is performed, and then the processing proceeds to S203. Details of the accuracy determination processing will be described later.

On the other hand, when it is determined that the inquiry has not been received in the determination processing of S201 (when the determination result is NO), the processing of S202 is skipped and the processing proceeds to S203.

In S203, processing of determining whether or not the read request of the matrix has been received is performed. This read request is sent from the accelerator 110 by the processing of S113 of FIG. 7 described above.

When it is determined in the determination processing of S203 that the read request has been received (when the determination result is YES), the processing proceeds to S204, read processing is performed, and then the processing proceeds to S205. Details of this read processing will also be described later.

On the other hand, when it is determined in the determination processing of S203 that the read request has not been received (when the determination result is NO), the processing of S204 is skipped and the processing proceeds to S205.

In S205, processing of determining whether or not the write request of the matrix has been received is performed. This write request is sent from the accelerator 110 by the processing of S102 of FIG. 6 or the processing of S116 of FIG. 7 described above.

When it is determined in the determination processing of S205 that the write request has been received (when the determination result is YES), the processing proceeds to S206. In S206, processing of transferring the matrix included in the write request to the LLC 200 and instructing the LLC 200 to write this matrix to the external memory 300 is performed, and thereafter, the processing proceeds to S207. In response to this write instruction, the LLC 200 writes this matrix to the external memory 300.

When it is determined in the determination processing of S205 that the write request has not been received (when the determination result is NO), the processing of S206 is skipped and the processing proceeds to S207.

In S207, processing of determining whether or not the notification of the range of the value taken by the exponent part in the value of each component of the matrix which is the target of the write request has been received is performed. This notification is sent from the accelerator 110 by the processing of S104 of FIG. 6 or the processing of S118 of FIG. 7 described above.

When it is determined that the notification has been received in the determination processing of S207 (when the determination result is YES), the processing proceeds to S208, and processing of adding the notified range of the value to the exponent part range table saved in the storage unit included in the memory controller 120 itself is performed. Thereafter, the processing returns to S201, and the above-described processing is repeated.

On the other hand, when it is determined that the notification has not been received in the determination processing of S207 (when the determination result is NO), the processing of S208 is skipped, and thereafter, the processing returns to S201 and the above-described processing is repeated.

The above processing is performed by the memory controller 120. When each processing of S202, S204, and S206 is ended, the processing may immediately return to S201 and the subsequent processing may be repeated.

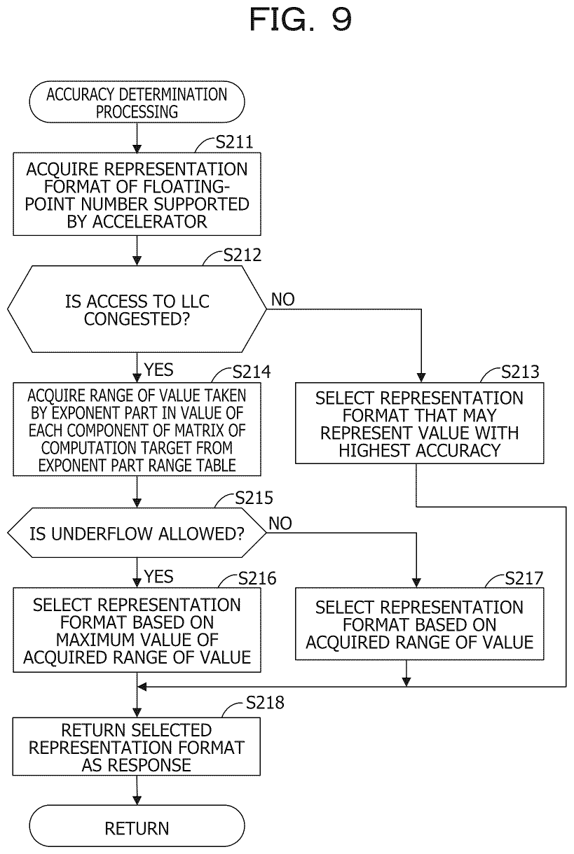

Next, details of the accuracy determination processing, which is the processing of S202 of FIG. 8, will be described. FIG. 9 is a flowchart illustrating processing contents of an example of the accuracy determination processing.

When the accuracy determination processing is started, first, in S211, processing of acquiring the representation format of the floating-point number in which the accelerator 110 supports the execution of the computation is performed.

Next, in S212, processing of determining whether or not the access to the LLC 200 is congested as described above is performed. When it is determined in this determination processing that the access is congested (when the determination result is YES), the processing proceeds to S214.

On the other hand, in the determination processing of S212, when it is determined that the access to the LLC 200 is not congested (when the determination result is NO), the processing proceeds to S213. Then, in S213, processing of selecting the representation format with the highest accuracy, among the representation formats which are acquired by the processing of S211 and in which the accelerator 110 supports the execution of the computation, is performed, and thereafter, the processing proceeds to the S218. Therefore, in the present embodiment where the accelerator 110 supports the execution of the computation on the floating-point numbers represented in the representation formats of the FP32, FP16, BF16, FP8, and FP19, the FP32 format is selected by the processing of S213.

In S214, processing of acquiring, from the exponent part range table, the range of the value taken by the exponent part in the value of each component of the matrix of the computation target, for example, the matrix to be read in the read processing (the processing of S204 of FIG. 8) performed subsequent to this accuracy determination processing is performed.

In S215, processing of determining whether or not an underflow is allowed in the matrix multiplication computation by the accelerator 110 is performed. In the present embodiment, it is assumed that whether or not the underflow is allowed is directly acquired from the CPU 410 or is notified via the accelerator 110.

In the determination processing of S215, when it is determined that the underflow is allowed (when the determination result is YES), the processing proceeds to S216, and when it is determined that the underflow is not allowed (when the determination result is NO), the processing proceeds to S217.

In S216, processing of selecting, from among the representation formats acquired in the processing of S211, a representation format that has, as the exponent part, a bit width capable of representing the maximum value in the range acquired in the processing of S214 and that has the smallest number of bits used to represent the value is performed. Thereafter, the processing proceeds to S218.

In S217, processing of selecting, from the representation formats acquired in the processing of S211, a representation format that has, as the exponent part, a bit width capable of representing both the maximum value and the minimum value in the range acquired in the processing of S214 and that has the smallest number of bits used to represent the value is performed. Thereafter, the processing proceeds to S218.

The selection of the representation format in the processing of S217 and S218 described above is performed by the method described above with reference to FIG. 5.

In S218, processing of sending the representation format selected by the processing of S213, S216, or S217 to the accelerator 110 having sent the inquiry, as the response to the inquiry about the information on the accuracy of the value of each component of the matrix which is the computation target is performed. Thereafter, the accuracy determination processing is ended, and the processing returns and proceeds to S203 of FIG. 8.

The processing described above is the accuracy determination processing.

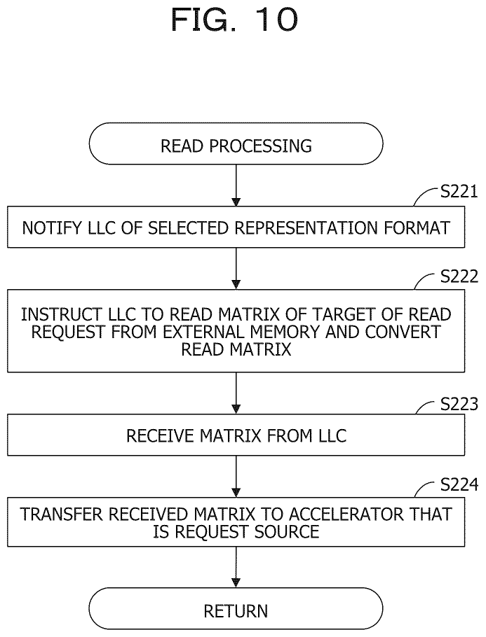

Next, details of the read processing which is the processing of S204 of FIG. 8 will be described. FIG. 10 is a flowchart illustrating processing contents of an example of the read processing.

When the processing of FIG. 8 is started, first, in S221, processing of notifying the LLC 200 of the representation format selected by the accuracy determination processing described above is performed.

Next, in S222, processing of instructing the LLC 200 to read the matrix of the target of the read request determined to have been received in the determination processing of S203 of FIG. 8 from the external memory 300 and to convert the accuracy of the value of each component of the read matrix is performed.

The LLC 200 having received the instruction by the processing of S222 reads the matrix of the target of the read request from the external memory 300. The LLC 200 performs conversion for reducing the accuracy of the value of each component of the read matrix by converting the representation format of each component of the read matrix into the representation format notified by the processing of S221, and sends the converted matrix to the memory controller 120.

In a case where the FP32 format is selected in the accuracy determination processing, for example, in a case where the representation format with the highest accuracy is selected by the processing of S213 of FIG. 9, the LLC 200 handles the matrix read from the external memory 300 as it is as the converted matrix.

In S223, processing of receiving the matrix converted by the processing of S222 from the LLC 200 is performed. In subsequent S224, processing of transferring the received matrix to the accelerator 110 which is a request source of the read request is performed. Thereafter, the read processing is ended, and the processing returns and proceeds to S205 of FIG. 8.

The processing described above is the read processing.

Each of the accelerator 110 and the memory controller 120 perform the respective processing described above, and thus, the computing system 1 may execute the matrix multiplication computation repeated hierarchically in a short processing time.

Although the disclosed embodiments and their advantages have been described in detail above, those skilled in the art may make various modifications, additions, and omissions without departing from the scope of the present disclosure as defined in the appended claims.

For example, in the accuracy determination processing of FIG. 9, a representation format that has, as the exponent part, a bit width capable of representing the range of the value taken by the exponent part of the value of each component of the matrix and that has the smallest number of bits used to represent the value is selected from among the representation formats of the floating-point numbers supported by the accelerator 110. Alternatively, the memory controller 120 may select, from among the representation formats of the floating-point numbers supported by the accelerator 110, a representation format designated by the user of the computing system 1 instructed from the CPU 410, and may return the selected representation format as a response.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computing system comprising:
a plurality of accelerators that perform matrix multiplication computations;
a cache memory that caches data of an external memory that saves a computation result by each of the plurality of accelerators; and
a controller configured to:
determine whether or not an access to the cache memory is congested; and
in a case where it is determined that the access is congested, control the cache memory to perform conversion for reducing accuracy of a value of each component of a matrix on the matrix read from the external memory in response to an access from one accelerator that is one of the plurality of accelerators and is configured to perform the matrix multiplication computation of the matrix and another matrix saved in the external memory, and to transfer the matrix.

2. The computing system according to claim 1, wherein
an accelerator that has output the matrix as the computation result, among the plurality of accelerators, obtains a range of a value taken by an exponent part in a value of each component of the matrix represented in a representation format of a floating-point number and notifies the controller of the range, and
the controller determines the accuracy after the conversion, based on the range.

3. The computing system according to claim 2, wherein
the conversion is conversion for representing the value of each component of the matrix in the representation format that has a bit width capable of representing a maximum value of the range as the exponent part and that reduces a number of bits used to represent the value.

4. The computing system according to claim 2, wherein
the conversion is conversion for representing the value of each component of the matrix in the representation format that has a bit width capable of representing both a maximum value and a minimum value of the range as the exponent part and that reduces a number of bits used to represent the value.

5. The computing system according to claim 2, wherein
the controller selects the representation format for the value of each component of the matrix after the conversion, from among options of the representation format.

6. The computing system according to claim 1, wherein
the one accelerator executes sequential addition with the accuracy before the conversion among multiplication and the sequential addition of a result of the multiplication, which are executed to perform a product-sum computation of components of the matrix and components of the other matrix, which is performed as the matrix multiplication computation of the matrix and the other matrix.

7. A method for controlling a computing system including a plurality of accelerators that perform matrix multiplication computations and a cache memory that caches data of an external memory that saves a computation result by each of the plurality of accelerators, the method comprising:
determining whether or not an access to the cache memory is congested; and
in a case where it is determined that the access is congested, control ling the cache memory to perform conversion for reducing accuracy of a value of each component of a matrix on the matrix read from the external memory in response to an access from one accelerator that is one of the plurality of accelerators and is configured to perform the matrix multiplication computation of the matrix and another matrix saved in the external memory, and to transfer the matrix.
